(19) United States
(12) Patent Application Publication
(10) Pub. No.: US 2025/0262536 A1
(43) Pub. Date: Aug. 21, 2025

(54) ELECTRONIC APPARATUS AND GAME ASSISTANCE METHOD

(71) Applicant: ASUSTeK COMPUTER INC., Taipei City (TW)

(72) Inventors: Fu-Ju Lai, Taipei City (TW); You-Ting Lin, Taipei City (TW); Li-Wei Chan, Taipei City (TW)

(73) Assignee: ASUSTeK COMPUTER INC., Taipei City (TW)

(21) Appl. No.: 19/044,638

(22) Filed: Feb. 4, 2025

(30) Foreign Application Priority Data
Feb. 21, 2024 (TW) 113106058

(51) Int. Cl. A63F 13/5375; A63F 13/52

(52) U.S. Cl. CPC A63F 13/5375; A63F 13/52

(57) ABSTRACT

An electronic apparatus and a game assistance method are provided. The game assistance method is adapted to the electronic apparatus. The method includes the following steps. A game application is executed, and a game screen of the game application is displayed. Text in the game screen is recognized. A target string is generated based on the recognized text. The target string is inputted into an application, and a floating window of the application is overlapped and displayed on the game screen through the display device.

### CROSS-REFERENCE TO RELATED APPLICATION

This application claims the priority benefit of Taiwan application serial no. 113106058, filed on Feb. 21, 2024. The entirety of the above-mentioned patent application is hereby incorporated by reference herein and made a part of specification.

### BACKGROUND

### Technical Field

The disclosure relates to an electronic apparatus and a game assistance method.

### Description of Related Art

With the advancement of technology, electronic apparatuses have become indispensable items due to their powerful performance and rich applications in the daily lives of modern people. For instance, using electronic apparatuses to play games has become a popular pastime. As the performance of electronic apparatuses improves day by day, game play methods and game types become increasingly diverse. At present, when a game player fails to pass a level in a specific game or is stuck at a level, the player has to stop the game first to search for the game walkthrough of the game most of the time before continuing with the game based on the searched game walkthrough. In other words, the act of searching for game walkthroughs will obviously interrupt the immersion of games. Further, game players have to enter keywords to query game walkthroughs through typing by themselves, so game players may have to switch back and forth between the game screen and the query screen to ensure that the query keywords meet expectations.

### SUMMARY

The disclosure provides a game assistance method adapted to an electronic apparatus including a display device. The method includes the following steps. A game application is executed, and a game screen of the game application is displayed. Text in the game screen is recognized. A target string is generated based on the recognized text. The target string is inputted into an application, and a floating window of the application is overlapped and displayed on the game screen through the display device.

The disclosure further provides an electronic apparatus including a display device, a storage device, and a processor. The storage device records a plurality of modules. The processor is coupled to the display device and the storage device, executes the modules, and is configured to execute the following steps. A game application is executed, and a game screen of the game application is displayed. Text in the game screen is recognized. A target string is generated based on the recognized text. The target string is inputted into an application, and a floating window of the application is overlapped and displayed on the game screen through the display device.

To sum up, in the embodiments of the disclosure, when running the game application, the text in the game screen is recognized. The target string generated based on the recognized text is inputted into the application, and the floating window of the application receiving the target string is overlapped and displayed on the game screen. Therefore, without interrupting the gaming experience, the electronic apparatus may use the text appearing on the game screen to implement specific functions, thus allowing a user to obtain a favorable gaming experience.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of an electronic apparatus according to an embodiment of the disclosure.

FIG. 2 is a flow chart of a game assistance method according to an embodiment of the disclosure.

FIG. 3 is a schematic view of a game screen and a floating window according to an embodiment of the disclosure.

FIG. 4 is a flow chart of a game assistance method according to an embodiment of the disclosure.

FIG. 5A is a schematic view of providing a text mark box and a candidate word list according to an embodiment of the disclosure.

FIG. 5B is a schematic view of determining a target string according to a user selection command according to an embodiment of the disclosure.

FIG. 5C is a schematic view of superimposing and displaying the floating window including a walkthrough search result on the game screen according to an embodiment of the disclosure.

FIG. 5D is a schematic view of a prompt message for copying target text according to an embodiment of the disclosure.

### DESCRIPTION OF THE EMBODIMENTS

Descriptions of the disclosure are given with reference to the exemplary embodiments illustrated by the accompanying drawings. Wherever possible, the same reference numbers are used in the drawings and the description to refer to the same or like parts. These embodiments are only part of the disclosure and do not present all implementation of the disclosure. More specifically, these embodiments serve as examples of the apparatus and method fall within the scope of the claims of the disclosure.

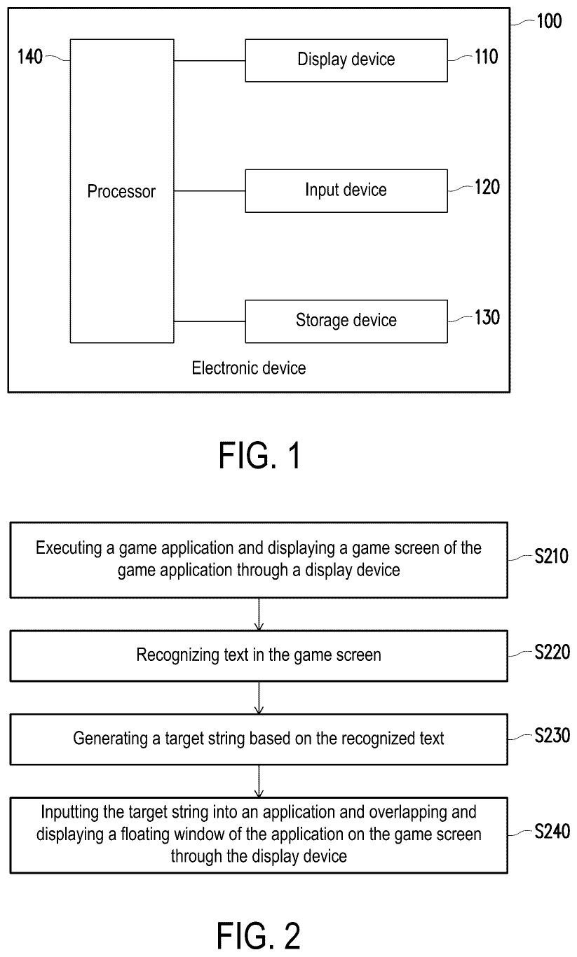

With reference to FIG. 1, a display apparatus 100 of this embodiment is, for example, a smart phone, a tablet computer, a notebook computer, or a desktop computer that can execute game applications, but the disclosure is not limited thereto. The electronic apparatus 100 includes a display device 110, an input device 120, a storage device 130, and a processor 140, and functions of these devices are described in the following paragraphs.

The display device 110 is used to display an image to a user. The display device 110 is, for example, a liquid crystal display (LCD), a light-emitting diode (LED) display, a field emission display (FED), an organic light-emitting diode (OLED) display, or other types of display devices, but the disclosure is not limited thereto.

The input device 120 is used to receive a user command inputted by the user. The input device 120 is, for example, a touch panel, a keyboard, a mouse, a microphone, a game controller, or other types of command input devices, but the disclosure is not limited thereto. In some embodiments, the touch panel and the display device 110 may be integrated into a touch screen.

The storage device 130 is used to store data such as a file, an image, a command, a program code, a software module, etc., and may be, for example, a fixed or movable random access memory (RAM) in any form, a read-only memory (ROM), a flash memory, a hard disc or other similar devices, an integrated circuit, and a combination thereof.

The processor 140 is, for example, a central processing unit (CPU), an application processor (AP), a programmable microprocessor for general or special use, a digital signal processor (DSP), a programmable controller, an application specific integrated circuit (ASIC), a programmable logic device (PLD), a graphics processing unit (GPU) or other similar devices, or a combination of the foregoing devices. The processor 140 may execute a program code, a software module, a command, etc. recorded in the storage device 130 to implement a game assistance method provided by the embodiments of the disclosure. The software module may be broadly construed to mean a command, a command set, a code, a program code, a program, an application, a software package, a thread, a procedure, a function, etc.

FIG. 2 is a flow chart of a game assistance method according to an embodiment of the disclosure. With reference to FIG. 1 and FIG. 2, the method provided by this embodiment is applicable to the electronic apparatus 100 provided by the foregoing embodiments, and steps of the game assistance method provided by this embodiment are described in detail as follows together with the various devices in the electronic apparatus 100.

In step S210, the processor 140 executes a game application and controls the display device 110 to display a game screen of the game application. To be specific, when the game application is executed, the display device 110 displays the game screen of the game application.

In step S220, the processor 140 recognizes text in the game screen. Generally, the game screen may include permanent static text, dynamic text for conditional prompts, or a combination thereof. The processor 140 can capture the game screen displayed by the display device 110 and use text recognition technology to perform text recognition on the game screen. The abovementioned text recognition technology is, for example, optical character recognition (OCR) technology. After performing text recognition on the game screen, the processor 130 may obtain the text in the game screen. In different embodiments, the processor 130 may perform text recognition on a complete region or a partial region of the game screen. The abovementioned partial region may be predetermined or set by the user.

In step S230, the processor 140 generates a target string according to the recognized text. In some embodiments, the processor 140 may treat all recognized text as the target string. Alternatively, in some embodiments, the processor 140 may use a portion of the recognized text as the target string. For instance, the processor 140 may select a portion of the recognized text as the target string according to a predetermined rule or based on the user command. In addition, in some embodiments, the processor 140 may further add other words that do not appear in the game screen to generate the target string.

In step S240, the processor 140 inputs the target string into an application and overlaps and displays a floating window of the application on the game screen through the display device 110. The application may include a browser, an instant messaging program, a document editing program, a drawing program, a clipboard application, or other applications that allow text input. For instance, the processor 140 may input the target string into a search engine of the browser, so that the search engine of the browser performs webpage search based on the target string. Alternatively, the processor 140 may input the target string into a conversation input field of the instant messaging program, so that the instant messaging program sends the target string to the conversation partner. Alternatively, the processor 140 may copy the target string directly into a document file of the document editing program.

It is worth mentioning that when the processor 140 inputs the target string into the application, the processor 140 may overlap and display the floating window of the application on the game screen through the display device 110. To be specific, when the processor 140 inputs the target string into an application by using an application programming interface (API), the processor 140 may overlap and display the floating window of the application on the game screen. For instance, the processor 140 may overlap and display the floating window of the browser on the game screen, and the floating window of the browser may include a web search result corresponding to the target text. Alternatively, the processor 140 may overlap and display a floating window of the instant messaging program on the game screen, and the floating window of the instant messaging program presents conversation content including the target text. Still alternatively, the processor 140 may overlap and display a floating window of the document editing program on the game screen, and the floating window of the document editing program presents the a document including the target text.

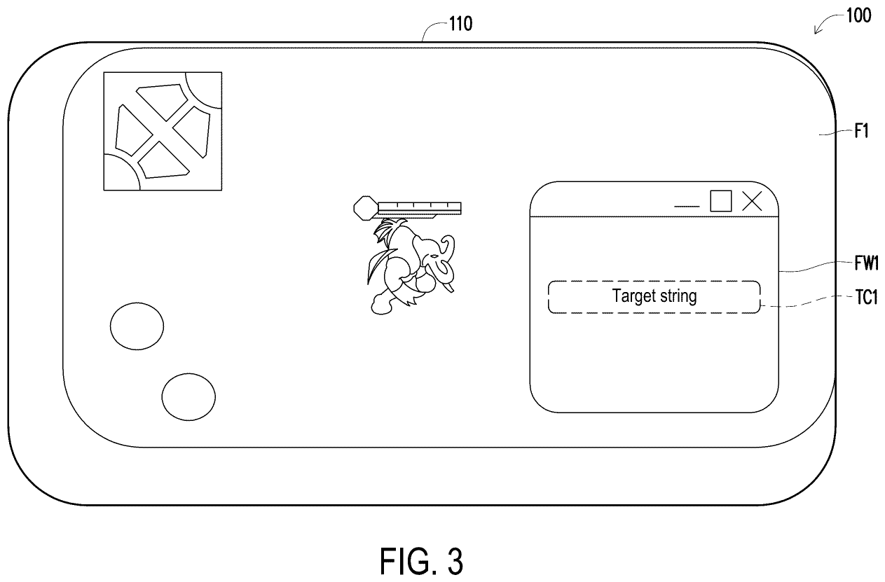

For instance, with reference to FIG. 3, which is a schematic view of a game screen and a floating window according to an embodiment of the disclosure. When the processor 140 executes the game application, the display device 110 displays a game screen F1. When the processor 140 inputs a target string TC1 into the application program, the processor 140 may overlap and display a floating window FW1 of the application program on the game screen F1 through the display device 110. A window range of the floating window FW1 is smaller than the game screen F1. Based on the above, the user can view the game screen F1 and the floating window FW1 at the same time without stopping the game or switching the game screen F1 to another screen and thus can simultaneously obtain a function or information provided by the application through the floating window FW1 during the game.

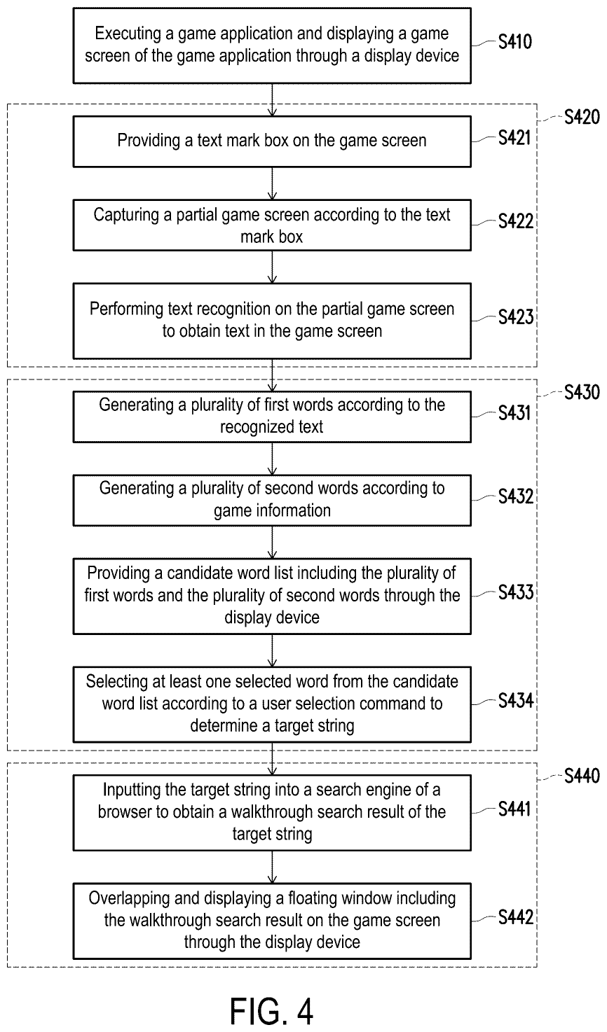

FIG. 4 is a flow chart of a game assistance method according to an embodiment of the disclosure With reference to FIG. 1 and FIG. 4, the method provided by this embodiment is applicable to the electronic apparatus 100 provided by the foregoing embodiments, and steps of the game assistance method provided by this embodiment are described in detail as follows together with the various devices in the electronic apparatus 100.

In step S410, the processor 140 executes a game application and controls the display device 110 to display a game screen of the game application. In step S420, the processor 140 recognizes text in the game screen. In this embodiment, step S420 may be implemented as steps S421 to S423.

In step S421, the processor 140 provides a text mark box on the game screen. The text mark box is superimposed and displayed on the game screen. The text mark box is used to mark a text region in the game screen that the user is interested in. In step S422, the processor 140 captures a partial game screen from the game screen according to the text mark box. In other words, the abovementioned partial game screen is formed by pixels located in the text mark box in the game screen.

In some embodiments, the processor 140 may adjust a position or a coverage size of the text mark box according to a user adjustment command. To be specific, when the processor 140 receives a user adjustment command applied to the text mark box through the input device 120, the processor 140 may adjust the position or the coverage size of the text mark box. For instance, when receiving a drag operation on a box boundary of the text mark box, the processor 140 may enlarge or reduce the text mark box. Alternatively, when receiving a drag operation within the text mark box, the processor 140 may move the text mark box from a first position to a second position.

In step S423, the processor 140 performs text recognition on the partial game screen to obtain the text in the game screen. Compared to performing text recognition on the entire game screen, performing text recognition on part of the game screen can not only improve processing speed, but also accurately obtain text content that meets user needs.

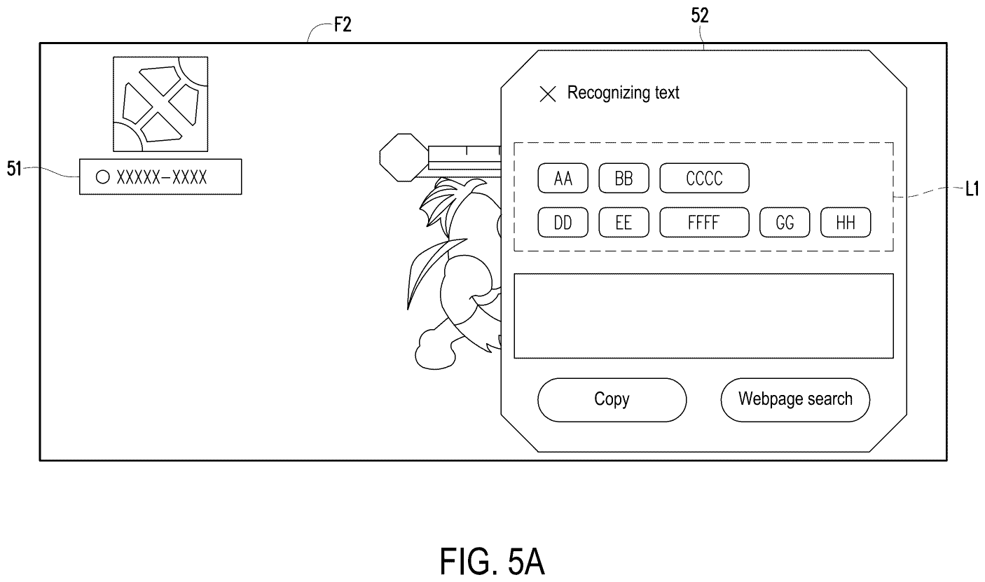

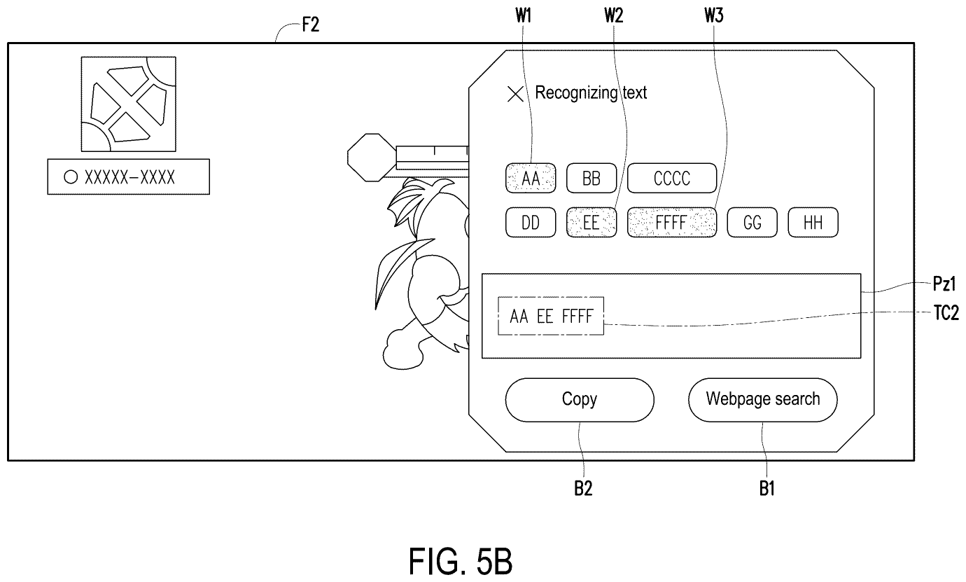

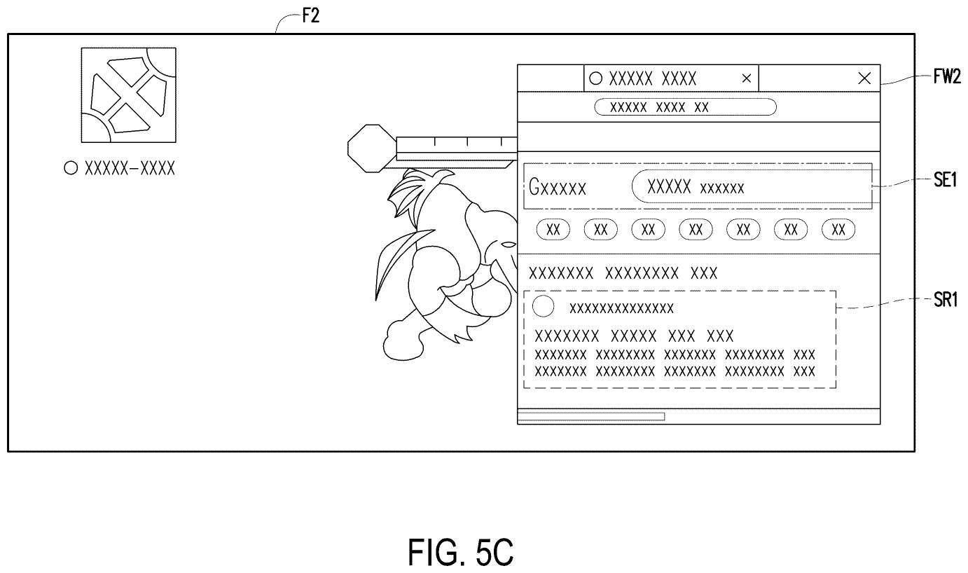

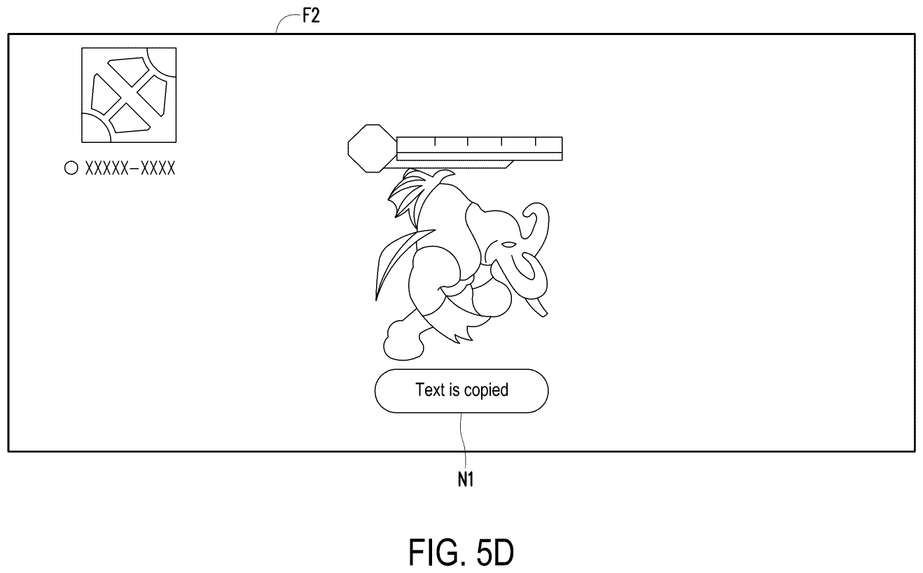

For instance, with reference to FIG. 5A, the display device 110 may display a game screen F2. The processor 140 may control the display device 110 to overlap and display a text mark box 51 on the game screen F2. The text mark box 51 may mark the text region in the game screen F2 that the user is interested in. The processor 140 may capture the partial game screen selected by the text mark box 51 from the game screen F2 to further recognize the text appearing in the partial game screen.

In step S430, the processor 140 generates a target string according to the recognized text. In this embodiment, step S430 may be implemented as steps S431 to S424.

In step S431, the processor 140 generates a plurality of first words according to the recognized text. To be specific, the processor 140 may generate one or a plurality of words or a phrase composed of a plurality of words according to the recognized text. The processor 140 may obtain these words and phrases from the recognized text according to a natural language processing technique (e.g., a semantic analysis model). For instance, assuming that the recognized text is “adventure with character A”, the first word obtained by the processor 140 is, for example, “character A”, “together”, “adventure”, or “adventure together”, etc.

In step S432, the processor 140 generates a plurality of second words according to game information. In some embodiments, the game information may include the game name. Alternatively, in some embodiment, the game information may include virtual characters, patterns, image objects, or game scene features in the game screen, etc. Through image recognition technology such as image object recognition or color recognition, the processor 140 may recognize virtual characters, patterns, image objects, game scene features, etc. in the game screen. In some embodiments, the processor 140 may use a convolutional neural network model or other machine learning models to recognize the screen content of the game screen to obtain the game information. After obtaining the above game information, the processor 140 may generate the plurality of second words according to the game information. For instance, the second words may be game names, virtual character names, game scene features, etc.

In step S433, the processor 140 provides a candidate word list through the display device 110. The candidate word list includes the plurality of first words and the plurality of second words. For instance, with reference to FIG. 5A, the display device 110 may display the game screen F2 and a user graphical interface 52 superimposed on the game screen F2. After recognizing the text in the text mark box 51 and obtaining the game information, the processor 140 may overlap and display a candidate word list L1 including the plurality of first words and the plurality of second words on the game screen F2.

In step S434, the processor 140 selects at least one selected word from the candidate word list according to a user selection command to determine the target string. To be specific, the processor 140 may select the at least one selected word from the plurality of first words and the plurality of second words in the candidate word list according to the user selection command. For instance, when the processor 140 receives a click command applied to a specific first word in the candidate word list through the input device 120, the processor 140 may set the first word as the selected word. One or more selected words selected by the user may be combined into the target string.

In some embodiments, the processor 140 may select a selection order of each selected word according to the user selection command and determine a concatenation order of each selected word in the target string. In other words, the concatenation order of each selected word in the target string is determined based on the order in which each one selected word is selected. For instance, when the selection order of the first selected words is earlier than the selection order of the second selected words, the second selected words are to be concatenated after the first selected words to form the target string. It can be seen that the user can not only decide the selected words by himself/herself, but can also decide the concatenation order of the selected words simultaneously.

In some embodiments, the processor 140 may display the target string in a preview interface. This preview interface is superimposed on the game screen. In this way, the user may edit the target string by viewing the preview interface to ensure that the target string meets the user's needs.

For instance, with reference to FIG. 5B, the display device 110 may display the game screen F2. When the processor 140 sequentially selects a selected word W1, a selected word W2, and a selected word W3 according to the user selection command, the selected words W1, W2, and W3 also appear sequentially in a preview interface Pz1 to form a target string TC2. More specifically, since the selection order of the selected word W1 is earlier than the selection order of the selected word W2, the selected word W2 is concatenated after the selected word W1. The preview interface Pz1 may be set next to the candidate word list L1, so that the user can view the preview interface Pz1 to edit the target string TC2.

In step S440, the processor 140 inputs the target string into an application and overlaps and displays a floating window of the application on the game screen through the display device 110. In this embodiment, step S440 may be implemented as steps S441 to S442.

In step S441, the processor 140 inputs the target string into a search engine of the browser to obtain a walkthrough search result for the target string. The search engine is, for example, Google search engine or Bing search engine, etc., and the disclosure is not limited thereto. In other words, the processor 140 may provide the target string as a key phrase to the search engine through the browser to drive the search engine to return the walkthrough search result for the target string.

In step S442, the processor 140 overlaps and displays the floating window including the walkthrough search result on the game screen through the display device 110. The walkthrough search result may include a webpage list, and this webpage list contains hyperlinks to a plurality of web pages obtained by performing a web search based on the target string. Therefore, after the user clicks on the hyperlink in the floating window of the browser, the floating window of the browser displays web content including a game walkthrough.

With reference to FIG. 5B, after the user determines the target string TC2, the user may click an option B1 in the user graphical interface. Therefore, with reference to FIG. 5C, the processor 140 may input the target string TC2 to the browser to drive the browser to send the target string TC2 to the search engine. Next, the display device 110 may overlap and display a floating window FW2 of the browser on the game screen F2. The floating window FW2 of the browser may include a keyword phrase input field SE1 and a walkthrough search result SR1 of the search engine. The keyword phrase input field SE1 has the target string TC2, and the walkthrough search result SR1 includes at least one webpage link and webpage introduction content. In this way, the user can see the walkthrough search result SR1 without stopping the game or switching the game screen to another screen.

In some embodiments, the processor 140 may copy the target string to a clipboard. The clipboard may be used as a temporary storage region for storing data or a file copied by the user of the electronic apparatus 100. The clipboard is, for example, a system clipboard under the operating system (OS) of the electronic apparatus 100 or an additionally designed special clipboard, and the disclosure is not limited thereto. The target string copied to the clipboard may be used by the user in other applications. With reference to FIG. 5D, after copying the target string to a clipboard, the processor 140 may control the display device 110 to superimpose a notification N1 on the game screen F2 to notify the user that the target string has been copied to the clipboard.

In view of the foregoing, in the embodiments of the disclosure, when running the game application, the text in the game screen may be recognized. The target string generated based on the recognized text may be inputted into the application, and the floating window of the application receiving the target string may be overlapped and displayed on the game screen. Therefore, without interrupting the gaming experience, the electronic apparatus may use the text appearing on the game screen to implement specific functions, thus allowing a user to obtain a favorable gaming experience. Besides, the target text used for searching for a game walkthrough may be edited by the user in a convenient way, so as to more accurately obtain the walkthrough search result that meet the user's needs.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A game assistance method, adapted to an electronic apparatus comprising a display device, the method comprising:
executing a game application and displaying a game screen of the game application;
recognizing text in the game screen;
generating a target string based on the recognized text; and
inputting the target string into an application and overlapping and displaying a floating window of the application on the game screen through the display device.

2. The game assistance method according to claim 1, wherein the step of recognizing the text in the game screen comprises:
providing a text mark box on the game screen;
capturing a partial game screen from the game screen according to the text mark box; and
performing text recognition on the partial game screen to obtain the text in the game screen.

3. The game assistance method according to claim 2, after the step of providing the text mark box on the game screen, the method further comprising:
adjusting a position or a coverage size of the text mark box according to a user adjustment command.

4. The game assistance method according to claim 1, wherein the step of generating the target string based on the recognized text comprises:
generating a plurality of first words according to the recognized text;
providing a candidate word list through the display device, wherein the candidate word list comprises the plurality of first words; and
selecting at least one selected word from the candidate word list according to a user selection command to determine the target string.

5. The game assistance method according to claim 4, wherein the step of generating the target string based on the recognized text further comprises:
generating a plurality of second words according to game information, wherein the candidate word list further comprises the plurality of second words.

6. The game assistance method according to claim 4, wherein the at least one selected word is combined into the target string, and the step of selecting the at least one selected word from the candidate word list according to the user selection command to determine the target string comprises:
selecting a selection order of each of the at least one selected word according to the user selection command and determining a concatenation order of each of the at least one selected word in the target string.

7. The game assistance method according to claim 6, wherein the step of selecting the at least one selected word from the candidate word list according to the user selection command to determine the target string further comprises:
displaying the target string in a preview interface, wherein the preview interface is superimposed and displayed on the game screen.

8. The game assistance method according to claim 1, wherein the application comprises a browser, and the step of inputting the target string into the application and overlapping and displaying the floating window of the application on the game screen through the display device further comprises:
inputting the target string into a search engine of the browser to obtain a walkthrough search result of the target string; and
overlapping and displaying the floating window comprising the walkthrough search result on the game screen through the display device.

9. The game assistance method according to claim 1, further comprising:
copying the target string to a clipboard.

10. An electronic apparatus, comprising:
a display device;
a storage device recording a plurality of modules; and
a processor coupled to the display device and the storage device, executing the modules, and configured to:
execute a game application and displaying a game screen of the game application,
recognize text in the game screen,
generate a target string based on the recognized text, and
paste the target string on an application and overlap and display a floating window comprising the application on the game screen through the display device.
